(19) United States
(12) Patent Application Publication
(10) Pub. No.: US 2004/0198455 A1
(43) Pub. Date: Oct. 7, 2004

(54) Selective terminal illumination based upon a displayed entry

(76) Inventor: Douglas Deeds, Fort Worth, TX (US)

Correspondence Address: STEVEN A. SHAW, NOKIA, INC., 6000 CONNECTION DRIVE, MD 1-4-755, IRVING, TX, 75039, US

(21) Appl. No.: 10/132,832

(22) Filed: Apr. 25, 2002

(51) Int. Cl. H04M 1/00

(52) U.S. Cl. 455/566; 455/67.11

(57) ABSTRACT

A terminal adapted to communicate via a mobile communications system includes a transmitter and a receiver for transmitting and receiving communications signals, respectively. Also, the terminal also includes a plurality of light emitting elements having a plurality of different colors, and a controller. In addition, the terminal can include a display for presenting at least one entry of a listing, such as a directory. The controller is capable of controlling the operation of the light emitting elements based upon a predefined color scheme associated with at least one predefined entry of a listing, such as at least one predefined listing presented upon the display. As such, the light emitting elements can illuminate at least a portion of the terminal, such as the display, such that a user of the terminal can identify the predefined entry based upon the color scheme illuminating the terminal.

### BACKGROUND

The present invention relates generally to terminals such as mobile telephones and, more particularly, relates to a terminal and a method for associating predefined types of illumination with one or more entries in a listing, such as a directory, thereby permitting a user to more readily identify a particular display.

Conventional terminals, such as mobile telephones also know as mobile stations, generally include a display capable of presenting any of a number of different displays, including menus and/or listings of entries from which choices are made. In this regard, conventional mobile telephones are generally capable of allowing a user to scroll through the menus and/or listings to make such choices. For example, many conventional mobile telephones store a telephone directory that includes a listing having a number of entries, with each including a name and an associated telephone number. To select a name or telephone number from the listing, then, the user typically scrolls through the names in the telephone directory until the user reaches the desired entry, as such is generally depicted by the display.

Traditionally, the displays of mobile telephones have consisted of a rather small liquid crystal display (LCD) with black text on a gray background, or a background backlit with a single color, such as light green or light blue. Whereas such displays are adequate to present the various displays of the mobile telephone in many situations, in other situations conventional displays have drawbacks. For example, in some circumstances the user is unable to identify or distinguish the entries of a listing, such as when the user has poor eyesight, has just awaken or is preoccupied with another matter, such as during a meeting. As such, conventional displays and methods of presenting listings in a mobile telephone often make it difficult for a user to scroll through menus and/or listings presented by the display when the user cannot clearly read the entries presented by the display.

### SUMMARY

In light of the foregoing background, embodiments the present invention provide an improved terminal and method of identifying particular entries in a listing, such as a directory. The terminal and method of the present invention associate at least one entry of the listing with a color scheme such that light emitting devices having the respective color can be driven upon presentation of the respective entry upon the display. In this regard, operation of the light emitting devices can be customized to illuminate the display or some other portion of the terminal. As such, a user of the terminal can identify selected entries in the listing by associating color schemes with the respective entries, a feature that is particularly advantageous in instances in which the user cannot clearly read the display, such as when the user has poor eyesight or is preoccupied with another matter such as a meeting. As such, the terminal and method of the present invention solve the problems identified by prior techniques and provide additional advantages.

According to one aspect of the present invention, a terminal adapted to communicate via a mobile communications system is provided. The terminal includes a transmitter and a receiver for transmitting and receiving communications signals, respectively. The terminal also includes a plurality of light emitting elements having a plurality of different colors. Additionally, the terminal can include a housing capable of encapsulating at least a portion of the light emitting elements, and a display for projecting at least one entry of a listing, where a predefined color scheme is associated with the at least one entry. To control the operation of the light emitting elements, the terminal includes a controller. In this regard, the controller controls the operation of the light emitting elements based upon the predefined color scheme associated with at least one predefined entry. As such, the light emitting elements can illuminate at least a portion of the terminal, such as the display.

According to one embodiment, at least one of the plurality of entries of the listing is associated with at least one caller group, and at least one caller group is associated with a color scheme. In this embodiment, the controller is capable of controlling the operation of the light emitting elements in response to the presentation of at least one entry upon the display based upon the color scheme associated with the caller group to which the entry belongs.

The terminal can also include a keypad having a plurality of keys. At least one entry of the listing may be associated with at least one key, such as for speed dialing. As such, the controller can be further capable of controlling the operation of the light emitting elements to illuminate the key(s) associated with the at least one entry while the at least one entry is presented upon the display.

According to various embodiments, the controller can control the operation of the light emitting elements to illuminate portions of the terminal. In this regard, the controller can control the operation of the light emitting elements to illuminate at least a portion of the display. For example, the controller can control the operation of the light emitting elements to illuminate a region of said display upon which the at least one entry is presented. Alternatively, the controller can control the operation of the light emitting elements to thereby illuminate all of the display. Further, the controller can control the operation of the light emitting elements to illuminate at least a portion of the housing of the terminal.

Embodiments of the present invention therefore provide an improved terminal and method that allows a user of the terminal to easily and conveniently identify entries in a listing, such as a directory, stored by the terminal. Thus, in situations where the user desires to view the entries, but cannot clearly read the display of the terminal, the terminal and method in accordance with an embodiment of the present invention allow the user to identify the entries in the listing by associating color schemes with which the display or other portion of the terminal is illuminated a based upon the presentation of the select entries upon the display.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a mobile communications system according to one embodiment of the present invention including a mobile station and a Base Station/MSC/Interworking function (BMI) to which the mobile station is bidirectionally coupled through wireless RF links;

FIG. 2 is a schematic diagram of a mobile station according to one embodiment of the present invention;

FIG. 3 is a schematic cross-section of a display of a mobile station according to one embodiment of the present invention;

FIG. 4 is a schematic diagram of a portion of the mobile station depicted in FIG. 2;

FIG. 5 is a flowchart illustrating various steps in a method of creating entries in a directory of a mobile station according to one embodiment of the present invention;

FIG. 6 is a flowchart illustrating various steps in a method of organizing one or more entries to one or more caller groups according to one embodiment of the present invention;

FIG. 7 is a flowchart illustrating various steps in a method of associating color schemes with one or more entries or caller groups according to one embodiment of the present invention;

FIG. 8 is a flowchart illustrating various steps in a method of operating a mobile station in the context of selecting one or more entries a directory of a mobile station according to one embodiment of the present invention; and

FIG. 9 is a schematic diagram of a mobile station according to one embodiment of the present invention including a region of the display and various keys illuminated.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

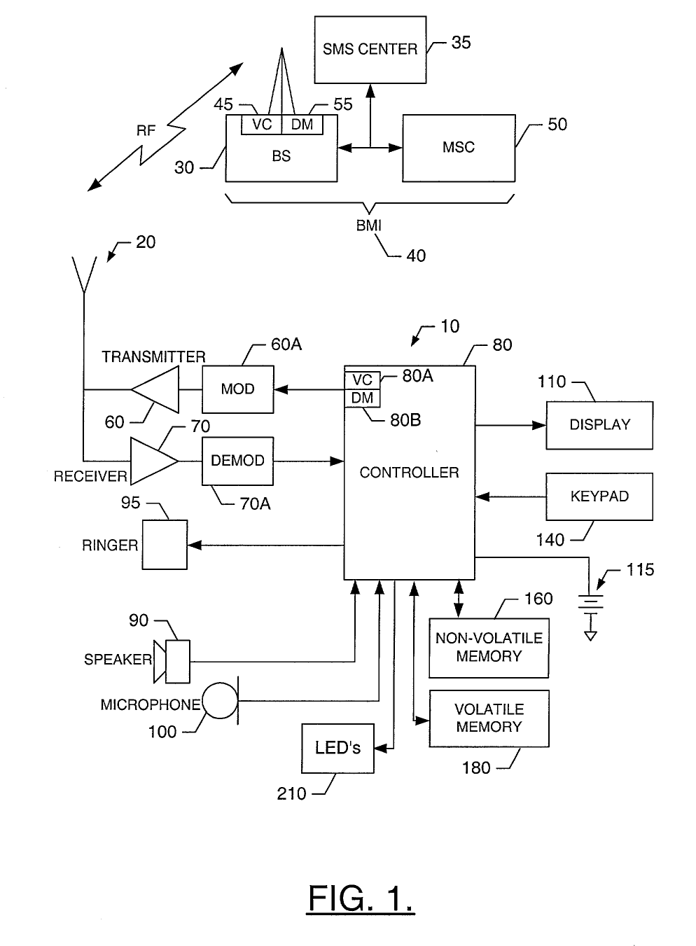

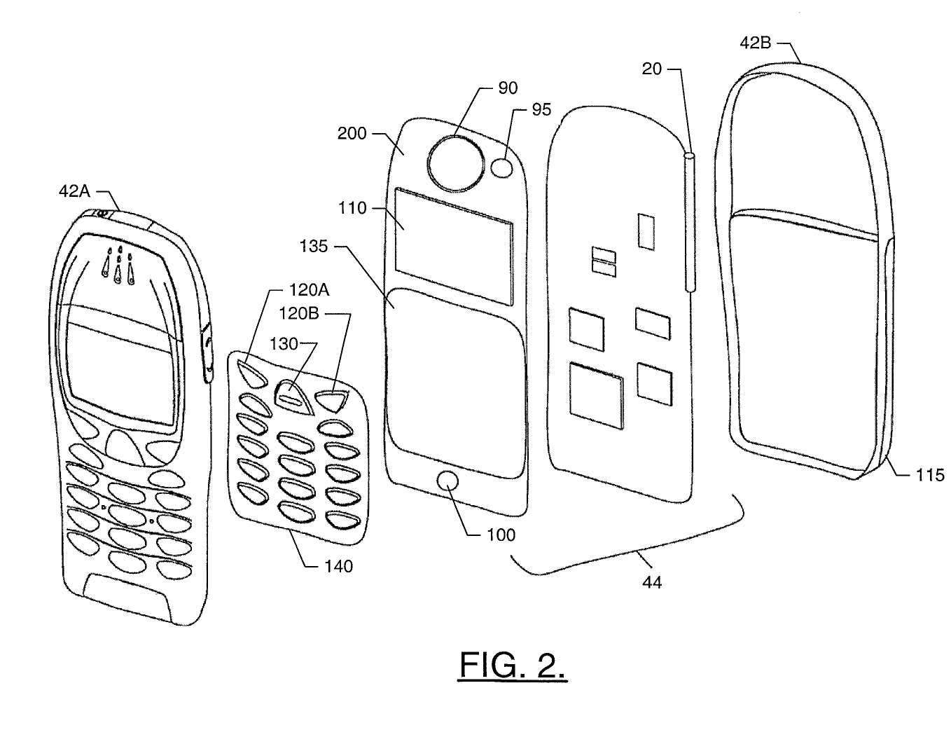

Referring to FIGS. 1 and 2, an illustration of one type of terminal, a mobile station, that would benefit from the present invention is provided. It should be understood, however, that the mobile telephone illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals, such as landline telephones, pagers and other types of voice and text communications systems, can readily employ the present invention. Moreover, the terminal and method of the present invention will be primarily described in conjunction with mobile communications applications. But the terminal and method of the present invention can be utilized in conjunction with a variety of other applications, both in the mobile communications industries and outside of the mobile communications industries.

The mobile station 10 includes an antenna 20 for transmitting signals to and for receiving signals from a base site or base station (BS) 30. The base station is a part of a cellular network that includes a mobile switching center (MSC) 50, an SMS center 35, voice coder/decoders (vocoders) (VC) 45, data modems (DM) 55, and other units required to operate the network. The MSC is capable of routing calls and messages to and from the mobile station when the mobile station is making and receiving calls. The MSC also provides a connection to landline trunks when the mobile station is involved in a call. As indicated above, the cellular network may also be referred to as a Base Station/MSC/Interworking function (BMI) 40.

As shown in FIG. 2, the mobile station includes a housing comprising front and back covers 42A and 42B, respectively, encapsulating mobile station circuitry 44 including a controller, memory and other elements used to operate the mobile station. The front and back covers can be made from any of a number of different materials, such as plastic. In one embodiment, however, the covers are made from an at least partially transparent material such that light emitted from light emitting elements encapsulated within the mobile station, as described below is capable of propagating at least partially through the covers. Alternatively, the covers can include a light emitting element comprising a material, such as an electroluminescent (EL) film, as such is known. In such an embodiment, the covers would comprise EL film and typically include a transparent shell layer disposed to protect the EL film from the outside environment.

Among the mobile station circuitry 44, the mobile station 10 includes a modulator (MOD) 60A, a transmitter 60, a receiver 70, a demodulator (DEMOD) 70A, and a controller 80 that provides signals to and receives signals from the transmitter and receiver, respectively. These signals include signaling information in accordance with the communications standard of the applicable cellular system, and also user speech and/or user generated data. For example, the communications standard can comprise the Global System for Mobile (GSM) communications standard, the Code Division Multiple Access (CDMA) communications standard or any of their progeny and the like. The mobile station may also be configured to meet the wireless application protocol (WAP) specification.

It is understood that the controller 80 includes the circuitry required for implementing the audio and logic functions of the mobile station. By example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 80A, and may include an internal data modem (DM) 80B.

The mobile station 10 also comprises a user interface that includes a conventional earphone or speaker 90, a ringer 95, a conventional microphone 100, a display 110, and a user input interface, all of which are coupled to the controller 80. The mobile station also includes a battery 115, such as a vibrating battery pack, for powering the various circuits that are required to operate the mobile station, as well as optionally providing mechanical vibration, as described below. The user interface can also include a scroll element to scroll through menu items featured on the display. The scroll element can comprise any of a number of known devices that allow for scrolling through displayed items, including a rolling cylinder, ball or the like. In the illustrated embodiment, however, the scroll element comprises scroll keys 130.

The display 110 can present any of a number of different displays, such as data, menus and/or listings. The display can also display areas for softkey functions that can be activated by pressing softkeys 120A and 120B located on a user input interface, described below. Whereas the display can comprise of any of a number of different elements, the display is preferably adapted to provide illumination having a plurality of colors. For example, according to one embodiment, the display comprises a light emitting element, such as EL film. In this embodiment, the display can be adapted to present a background having at least one color. Additionally, the display can be adapted to present text and other displays having at least one color that differs from the color of the background.

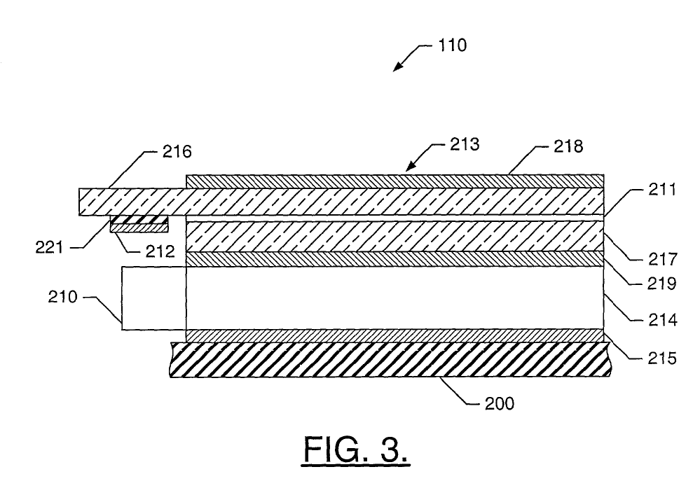

According to another embodiment, illustrated in FIG. 3, the display includes a liquid crystal display (LCD) 211 being driven by a driver 212, as such is known to those skilled in the art. The LCD has a display region 213 for presenting the different displays, such as data, menus, softkey functions and/or listings. A light guide 214 receives colored light from emitting elements, such as light emitting diodes (LED's) 210 disposed upon a flexible substrate 200, as described below. Whereas the light guide can receive light from any of a number of different LED's, with each having any one of a number of different colors, in one embodiment the light guide receives colored light from tunable LED's 210 capable of producing a plurality of colors. Additionally, or alternatively, one or more LED's can comprise a set of LED's capable of providing one or more select colors, such as red, blue and green.

As the light guide 214 receives the colored light, the light guide projects the colored light onto the display region 213 of the LCD 211 with the aid of a reflector 215. The display 110 of the illustrated embodiment also includes an upper glass sheet 216 overlying the LCD and a lower glass sheet 217 between the light guide and the LCD. Upper and lower polarizers 218 and 219 sandwich the glass sheets and the LCD between them. To further improve the quality of the resulting color illumination, a diffuser 219 is advantageously provided between the light guide and the lower glass sheet. The driver 212 may be on the upper or lower glass sheets, or on a flex 221 which is connected to the glass, or on a printed wiring board (not shown). If the driver is on the printed wiring board, the connection between the printed wiring board and the LCD can be accomplished, for example, by elastomer or flex. For more details on such a display, see European Patent Application No. EP 1109147 entitled: System for Color Illumination of a Display, filed Nov. 27, 2000.

While the display 110 depicted in FIG. 3 is described such that the entire display region of the LCD 211 is illuminated with a single color of light, the display can be configured to have a plurality of regions, each of which can be separately illuminated with the same or a different color. For example, the display can be configured to present multiple entries at one time. In this example, the display can be configured to have regions, with one or more entries in each region. By separately illuminating each region, the different entries can be individually highlighted.

Referring back to FIG. 2, the mobile station 10 also generally includes a user input membrane, such as a keypad membrane 135, and a user input interface, such as a keypad 140, which collectively allow the mobile station to receive data. As described herein the user input membrane comprises a keypad membrane and the interface comprises a keypad, but it should be understood that the user input interface can comprise any of a number of other devices allowing the mobile station to receive data, such as a touch display or other input device. The keypad includes the conventional numeric (0-9) and related keys (#, *), and other keys used for operating the mobile station. In addition to the softkeys 120A and 120B, the other keys may include, for example, a SEND key, various menu scrolling keys and a PWR key. Whereas the keypad can be made from any of a number of different known materials, the keypad is preferably made from a partially transparent material such that at least a portion of light emitted from light emitting elements positioned on the flexible substrate 200 (described below) will propagate through the keypad to thereby illuminate at least a portion of the keypad.

To store data upon receipt from the various sources, the mobile station includes volatile memory 180, such as volatile Random Access Memory (RAM) including a cache area for the temporary storage of data. The mobile station can also include non-volatile memory 160, which can be embedded and/or may be removable such as a removable Subscriber Identification Module (SIM). The non-volatile memory can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile station to implement the functions of the mobile station. For example, the memories, and particularly the non-volatile memory, can include a directory, such as a telephone directory, of telephone numbers of selected telephones, including mobile and landline telephones, as well as a name associated with each of the telephone numbers. The memories can also include computer program products that control the operation of all or a portion of the controller 80 to thereby implement the present invention. The controller, which can include embedded cache memory, generates appropriate commands and controls the other component blocks of the mobile station.

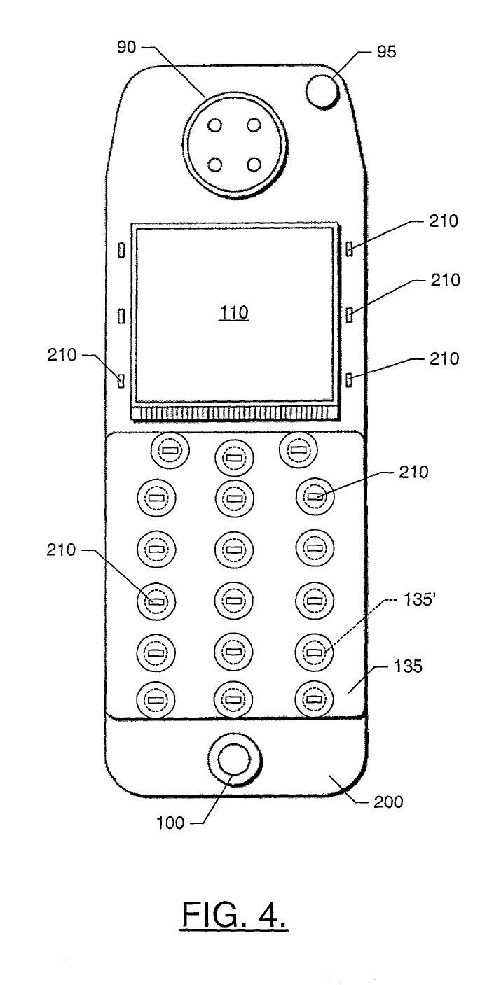

In one embodiment shown in FIG. 4, a flexible substrate 200 carries the display 110, the microphone 100, the speaker 90, a ringer 95, and the keypad membrane 135 that includes a plurality of keypad sensors 135′. The flexible substrate also carries a plurality of light emitting elements, such as light emitting diodes (LED's) 210. In this regard, each LED can comprise a tunable LED capable of providing plurality of different colors. Additionally, or alternatively, one or more LED's can comprise a set of LED's including a plurality of LED's each capable of providing at least one color. In such an embodiment, each set of LED's can include any of a number of different LED's, with each having any one of a number of different colors but, in one embodiment, each set of LED's comprises red, blue and green LED's. The tunable LED's can be arranged on the substrate in any one of a number of different manners to thereby illuminate the mobile station and the display. For example, three LED's can be arranged along each of the short edges of the display. Each LED can be configured to illuminate a respective region of the display or to cooperate with the other LED to collectively illuminate the entire display. Alternatively, all or a respective region of the display can be illuminated with another type of light emitting element, such as EL film, as described above. In the illustrated embodiment, one tunable LED can also be arranged to overlie each keypad sensor such that the LED's are capable of illuminating individual keys of the keypad 140. Alternatively, in embodiments where the display comprises EL film, EL film can additionally be arranged to overlie the keypad sensors to thereby illuminate the individual keys of the keypad. Also, one or more LED's, tunable or otherwise, can be arranged on the front cover 42A or the back cover 42B of the mobile station to effectively illuminate at least a portion of the housing.

The mobile station 10 is capable of being configured, such as by a user, to customize operation of the mobile station, as well as customize data stored in memory, such as non-volatile memory 160 and/or a removable SIM. In this regard, the user can configure a directory, such as a telephone directory, stored in memory to include at least one entry consisting of a name and an associated telephone number, as well as to configure the entries in the directory, such as by organizing one or more entries into one or more caller groups. Also, the user can configure the controller 80 to speed dial a selected entry in the directory. In addition, the user can configure the controller to operate the ringer 95, LED's 210 and/or vibrating battery 115 based upon selected entries stored in the directory, if so desired.

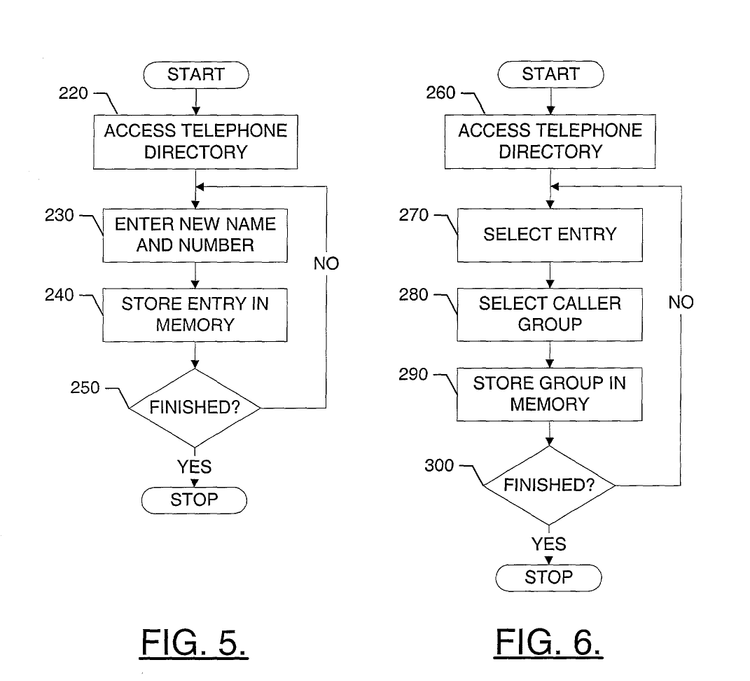

Referring to FIG. 5, the user can configure a directory of the mobile station 10 by entering names and associated telephone numbers in the directory stored in memory, such as in non-volatile memory 160 or on a removable SIM. The names and telephone numbers can be entered and stored in any one of a number of manners but, according to one embodiment, the user first accesses the directory from a main menu, as shown in block 220. Thereafter, the user enters a name and telephone number, for example “Mark” and 555 123 4567 respectively, as shown in block 230. The mobile station 10 can receive the name and telephone number in any one of a number of different manners but, according to one embodiment, the name and telephone number are received via the keypad 140 on the user interface of the mobile station. In this regard, each character of the name and telephone number can be produced through a specific key or as a combination of more than one key. As such, the pressing of one or more keys corresponds to a specific character, which can be displayed on the mobile station's display 110 in response to the pressing of the key. Additionally or alternatively, a tone having a predetermined pitch can be reproduced in response to the pressing of the key(s), such as through the speaker 90.

As an alternative, the name and telephone number can be received via the softkeys 120A and 220B, and/or the scroll keys 130 by selecting the characters from a menu. The name and telephone number can also be received via an infrared transceiver of the mobile station or other means of local data transfer (not shown). Additionally, or alternatively, the name and telephone number can be generated by voice recognition routines stored in memory in response to an audible input via the microphone 100, as such is known.

After the user enters the name and telephone number, the user stores the entry in memory, such as in non-volatile memory 160 or a removable SIM, as illustrated in block 240. The user can then indicate whether the user desires to make more entries having different names and/or telephone numbers, as shown in block 250. For example, the user can make one or more additional entries, such as one for a colleague from work, entered as “David”, and an entry for the user's bank manager, entered as “Bank Manager” having telephone numbers 555 876 5432 and 800 098 6789, respectively.

Referring now to FIG. 6, after saving the entries that have been entered, the user can arrange one or more of the stored entries into caller groups by associating one or more entries with one or more caller groups. For example, the user can arrange the entries into groups such as “Friends,” “Very Important Persons (VIPs),” “Family,” “Colleagues” and “Others.” The entries can be associated with the caller groups in any one of a number of manners but, according to one embodiment, the user first accesses the directory (shown in block 260), which is thereafter displayed by the display 110. The directory can be displayed in any one of a number of different manners and, according to one embodiment, the directory is displayed in groupings of one or more entries in alphabetical order. Alternatively, upon access of the directory, the controller 80 can display a search field where the user can input through the keypad a searchable alphanumeric string of characters. And by appropriate key selection, the controller can search the directory and thereafter display one or more contacts. For more information on such a method by which to access entries on the directory, see U.S. Pat. No. 6,049,796 entitled: Personal Digital Assistant with Real Time Search Capability, issued Apr. 11, 2000.

However the entries are displayed on the display 110, the user can select a desired entry upon display of the directory. For example, while the directory is displayed, the user can scroll through the entries until the user locates a desired entry (e.g., “Mark”), as shown in block 270. The user can then select the desired entry and thereafter select a caller group (e.g., “Family”) that the user desires to associate with the selected entry, as illustrated in block 280. If the desired caller group has not yet been established in the directory, however, the user can create a new caller group and thereafter enter the name of the new caller group. In this regard, any new caller group can be established before arranging the entries or as the user arranges the entries. At this point it should be noted that as used herein, data such as entries in the directory, can be scrolled through and selected according to any of a number of manners but, according to one embodiment, the data is scrolled through using scroll keys 130 and selected using a specified key on the keypad 140, such as one of the softkeys 120A or 120B.

After selecting or otherwise establishing the caller group, the user can store the association of the entry with the caller group in memory, and thereafter arrange other entries if so desired, as shown in blocks 290 and 300. For example, using the example entry “David” from above, the user can locate “David” in the directory and thereafter associate the entry with the caller group “Colleagues”. Likewise, using the example entry “Bank Manager” from above, the user can locate “Bank Manager” in the directory and thereafter associate the entry with the caller group “VIPs.” It will be appreciated that although each entry can be associated with one caller group, with each caller group including a plurality of entries, one entry can be associated with more than one caller group, and one or more caller groups can include only one entry. Further, the directory can include one or more entries that are not associated with any caller group.

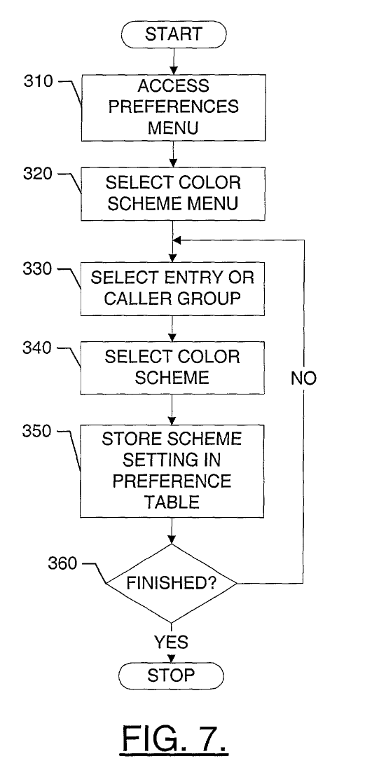

In addition to arranging one or more entries into caller groups, the user can likewise configure illumination of the mobile station 10, including the display 110, according to one or more entries and/or caller groups. In this regard, whereas the illumination can be configured in any one of a number of manners, according to one embodiment, depicted in FIG. 7, the user configures the illumination by first accessing the preference menu, as illustrated in block 310. From the preference menu, the user selects a color scheme menu, as shown in block 320. Then, from the color scheme menu, the user can select an entry (e.g., “Mark”) or caller group (e.g., “Family”), as shown in block 330. After selecting the entry or caller group, the user selects a color scheme, such as continuous green illumination, as illustrated in block 340. The color scheme associated with the selected entry or caller group is then stored in the preference table held in memory, as shown in block 350.

After storing the color scheme, the user can then assign color schemes to other entries and/or caller groups, as shown in block 360. If the user desires to make further color scheme selections, the user selects another entry or caller group from the color scheme menu and thereafter repeats the process in a fashion similar to that described above. For example, using the example caller groups identified above, the user can select the caller group “Colleagues” and decide upon slow, steady amber pulses. Similarly, the user can select the caller group “VIP” and thereafter choose irregular, rapidly flashing red pulses. As is apparent from the aforementioned examples of illumination settings, the user can configure different types of illumination, in addition to merely configuring the color of illumination. In this regard, the user can configure the LED's 210 to pulse according to any one of a number of different sequences to thereby trace a pattern, if so desired.

As explained below in conjunction with the operation of the mobile station 10, illumination of the mobile station will be provided based upon the color schemes associated with at least one predetermined entry in the directory, such as when a respective entry is presented on the display 110. Different portions of the mobile station can be illuminated in accordance with the illumination associated with the respective entries. In one advantageous embodiment, the display or at least a portion of the display, upon which a respective entry is presented, is illuminated in accordance with the type of illumination associated with the current entry. Alternatively, the display can present multiple entries at one time. In this instance, different regions of the display can be illuminated in different fashions with each region of the display being illuminated in accordance with the type of illumination associated with the entry presented in that region of the display. Alternatively, the entire display can be illuminated in the same fashion even in the instance in which multiple entries are presented upon the display, with the illumination typically being in accordance with the primary entry that could presently be selected. Although the display is advantageously illuminated, the housing or a portion of the housing could be illuminated in a similar fashion, either in addition to or instead of the display.

In another advantageous embodiment, all or a portion of the mobile station 10 can be so illuminated upon depressing one or more keys of the keypad 140 to thereby dial of the respective entries. Additionally, or alternatively, all or a portion of the mobile station can be so illuminated after depressing the key(s) and/or as the mobile station places an outgoing call to the respective telephone number. In this embodiment, the keys depressed to dial the respective entries can be keys associated with the entry for speed dialing, as such is known. Additionally, or alternatively, the keys depressed can be the first keys of the respective telephone number, with the mobile station adapted to recognize the depressed keys and complete the respective telephone number, if so desired. In this embodiment, all or a portion of the mobile station can be illuminated to have the color associated with the speed dial entry and/or the telephone number being dialed.

In addition to configuring the illumination of the mobile station 10, including the display, the user can configure one or more entries for speed dialing. The user can also configure the ringing tone of the mobile station 10 according to one or more entries and/or caller groups. In this regard, the user generally configures the ringing tone of the mobile station according to entry and/or caller group by associating one or more entries and/or caller groups with one or more distinct ringing tones or tunes. The ringing tones or tunes can be configured based upon the entries and/or caller groups in any one of a number of manners known in the art. Just as the user can configure the ringing tone or tune and the illumination according to one or more entries or caller groups, the user can also configure vibration of the vibrating battery 115 or other vibration device according to one or more entries or caller groups.

Further, the housing of the mobile station may be at least partially comprised of a piezoelectric material, such as the EMFIT brand electret-film sensor manufactured by Emfitech, Ltd. of Vaajakoski, Finland. In this regard, the housing can generate electrical signals in response to squeezing of the housing or the user can receive information from the vibration of the housing. Thus, the character(s) can be received as a series of coded signals, such as Morse Coded signals, input by squeezing the housing in accordance with the predetermined mnemonic code. For example, the characters can be received as coded signals by squeezing the housing in a series of squeezes held for shorter and longer periods of time to generate dots and dashes, respectively, for a Morse Coded message. The user may also feel the dots and dashes from the vibrations of the piezoelectric-type material.

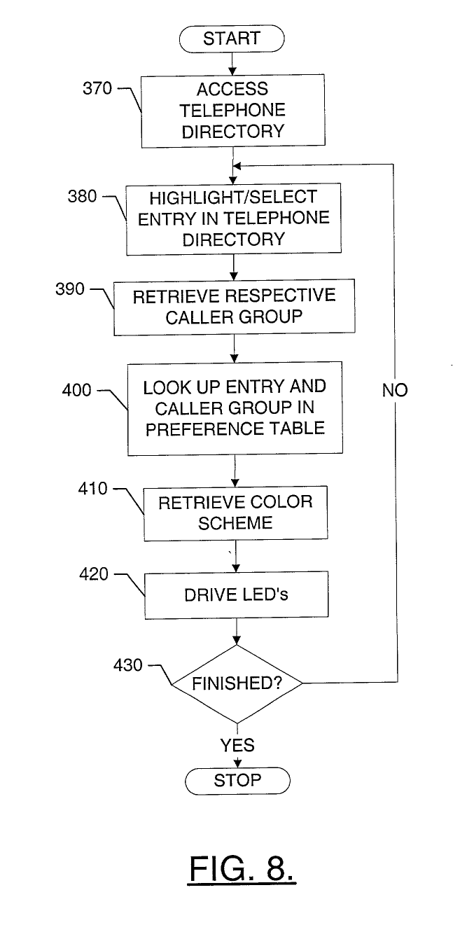

Operation of the mobile station 10 with respect to illuminating all or a portion of the mobile station based upon a predetermined entry in the directory according to one embodiment will now be described. Referring to FIG. 8, to select an entry in the directory, the user can first access the directory, as shown in block 370. Upon access, the controller can display the entries of the directory on the display 110. As stated before, the telephone directory can be displayed in any one of a number of different manners and, according to one embodiment, the directory is displayed in groupings of one or more entries in alphabetical order. Alternatively, upon access of the directory, the controller can display a search field where the user can input through the keypad 140 a searchable alphanumeric string of characters. And by appropriate key selection, the controller can search the directory and thereafter display one or more entries. Alternatively, the user can alternatively input through the keypad all or a portion of the telephone number of a respective entry in the directory, such as the keys associated with the entry for speed dialing or the first keys of the telephone number if the mobile station is adapted to recognize the first keys and thereby complete the respective telephone number. It should be understood, however, that in embodiments where the user inputs all or a portion of the telephone number of the respective entry, the display need not display the telephone number entered or any other portion of the respective entry.

However the entries are presented on the display 110 or otherwise input, one of the entries will be the primary entry, i.e., the entry that would be chosen if the user made a selection. For example, if only one entry is displayed or input, the selected entry is the displayed or input entry. If more than one entry is displayed, however, the selected entry will generally comprise the first entry, with the first entry typically being the entry listed above the other entries on the display. If the primary entry belongs to a caller group, the controller identifies to which caller group the entry belongs, as shown in block 390. For example, the controller can identify that the entry “John” belongs to caller group “Colleagues.” For the entry or caller group, then, the controller looks up the corresponding entry or caller group in the preference table stored in memory (shown in block 400), and retrieves the color scheme associated with the entry or caller group, as shown in block 410.

At this point it will be understood that if the entry is associated with a color scheme and the entry is also associated with a caller group having a different associated color scheme, the controller 80 will preferably prioritize one of the color schemes over the other. For example, the controller can generally prioritize the color scheme associated with the entry over that associated with the caller group such that the illumination will be dictated by the color scheme associated with the entry.

Additionally, for each entry that is not associated with a color scheme and is not otherwise associated with a caller group having a color scheme, a default color scheme can be identified. As such, the default color scheme will be displayed in instances in which the primary entry is otherwise not associated with a color scheme.

After retrieving the color scheme or identifying a default color scheme, the controller 80 drives the LED's 210 based upon the color scheme to thereby illuminate all or a portion of the display 110 or other portions of the mobile station 10, as shown in block 420. For example, using the example described above with the selected entry “John” belonging to the caller group “Colleagues,” the controller drives the tunable LED's 210 to output an amber color. As described above, the mobile station of one advantageous embodiment is configured such that the display or at least that region of the display in which the primary entry is presented is illuminated in accordance with the predefined color scheme associated with the primary entry. In addition, or alternatively, other portions of the mobile station can be simultaneously illuminated. For example, the housing can include EM film that can be driven to illuminate all or a portion of the housing in accordance with the color scheme associated with the primary entry. Regardless of the portion of the mobile station that is illuminated, the illumination will assist in the user's identification of a particular entry from the directory since the user can scroll through the directory until the display or some other portion of the mobile station is illuminated in accordance with the color scheme that is associated with the particular entry, i.e., the user can more readily determine that the display or some other portion of the mobile station is appropriately illuminated than the user can spot an unilluminated particular entry in the directory.

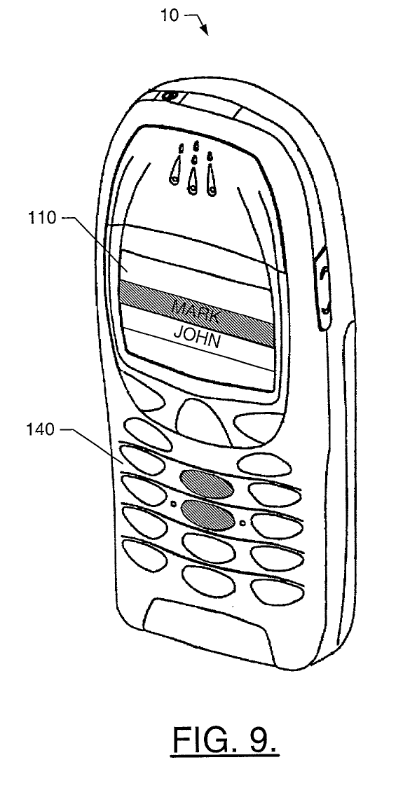

In addition to driving the LED's based upon the color scheme associated with the entry so as to illuminate the display or some other portion of the mobile station, the controller can also drive additional LED's so as to illuminate the one or more keys of the keypad 140 that have been designated to provide speed dialing for the primary entry, if the entry has been so configured. In this regard, the controller can also drive LED's arranged above or adjacent the keypad sensors 135′ underneath the respective key(s) such that the LED's are capable of illuminating the respective keys(s). The controller can also drive the LED's associated with the respective key(s) to provide illumination in accordance with the same color scheme associated with the primary entry or in accordance with another color scheme, as desired. Thus, as illustrated in FIG. 9, two entries of the directory correspond to “Mark” and “John,” where “Mark” represents the primary entry and is associated with the keys (2) and (5) for speed dialing. Also as illustrated, the entry for “Mark” is associated with a green color scheme, thus, the region of the display presenting the entry “Mark,” is illuminated green, as are the keys (2) and (5).

In embodiments where the controller drives the LED's to illuminate the keys of the keypad as well as all or a portion of the display in accordance with the color scheme associated with the primary entry, the controller can illuminate the key(s) designated for speed dialing in accordance with a color scheme different than that associated with the primary entry. As such, the key(s) designated with speed dialing illuminate with a different color than the keys illuminated in accordance with the color scheme associated with the primary entry. Thus, in accordance with the example illustrated in FIG. 9, if the controller drives the LED's to illuminate all the keys of the keypad green, the controller will illuminate the keys (2) and (5) (associated with speed dialing) a different color, such as red. Thus, by driving the LED's to illuminate the key(s) designated for speed dialing of the primary entry, a user who cannot clearly read the primary entry can otherwise identify the entry, as well as key(s) associated with the entry for speed dialing, based upon the color scheme associated with the color scheme.

It will be appreciated that as the preference table for an entry or caller group can also include a distinct ringing tone and/or vibration, the controller 80 can also retrieve the ringing tone and/or vibration at the time the controller retrieves the color scheme. In this regard, as the controller drives the LED's 210, the controller can also operate the ringer 95 and/or the vibrating battery 115 based upon the ringing tone and/or the vibration, respectively, in order to provide additional indications to the user as to the primary entry if so desired.

Once the controller 80 begins to drive the LED's 210, the controller can continue to drive the LED's (as well as the ringer and/or vibrating battery if so operated) for a predetermined period of time, or until a different entry becomes the primary entry or the user otherwise exits the directory, or until the user elects to place an outgoing call to the telephone number of the primary entry, such as by pressing a “Talk” key. It will be understood that even though the controller can continue to drive the LED's until the user elects to place an outgoing call, the controller can continue to drive the LED's for a predetermined time period thereafter, if so desired. An entry can cease to be the primary entry in any one of a number of manners, such as by scrolling through the entries in the directory, such as by operating scroll keys 130 (shown in block 430). In this situation, the illumination provided in accordance with the present invention would generally repeatedly change as the user scrolls through the directory and different entries become the primary entry. For example, the user can scroll through the entries in the directory, with the display presenting only one entry at a time. Alternatively, if the display 110 presents more than one entry, the user can scroll through the entries with the primary entry being a designated one of the displayed entries, such as the uppermost entry.

As described above, the illumination of at least a region of the display 110 or some other portion of the mobile station 10 in accordance with the color scheme associated with the primary entry is helpful to users, particularly users with poor eyesight or preoccupied with other matters, to readily locate a particular entry from a listing, such as a directory. While the present invention has been described in conjunction with the selection of an entry from a directory, the present invention is also useful for selecting entries from other listings or menus presented upon the display of the mobile station by again associating predefined color schemes with the respective entries.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A terminal adapted to communicate via a communications system, wherein the terminal comprises:
a transmitter and a receiver for transmitting and receiving communications signals, respectively;
a plurality of light emitting elements having a plurality of different colors; and
a controller capable of controlling the operation of the light emitting elements based upon a predefined color scheme associated with at least one predefined entry of a listing.

2. A terminal according to claim 1 further comprising a display for presenting the at least one entry of the listing, wherein a predefined color scheme is associated with the at least one entry, and wherein said controller is capable of controlling the operation of the light emitting elements in response to a presentation of the at least one entry upon said display based upon the predefined color scheme associated with the at least one entry.

3. A terminal according to claim 2 further comprising a memory having a directory stored therein, wherein the directory includes a plurality of entries capable of presentation upon said display.

4. A terminal according to claim 3, wherein at least one of the plurality of entries of the directory is associated with at least one caller group, wherein at least one caller group is associated with a color scheme, and wherein said controller is capable of controlling the operation of the light emitting elements in response to the presentation of at least one entry upon said display based upon a color scheme associated with the caller group to which the at least one entry belongs.

5. A terminal according to claim 2 further comprising a keypad including a plurality of keys, wherein the at least one entry presented upon said display is associated with at least one key, and wherein said controller is further capable of controlling the operation of the light emitting elements to also illuminate the at least one key associated with the at least one entry.

6. A terminal according to claim 2, wherein said controller is capable of controlling the operation of the light emitting elements to thereby illuminate at least a portion of the terminal.

7. A terminal according to claim 6, wherein said controller is capable of controlling the operation of the light emitting elements to thereby illuminate at least a portion of said display.

8. A terminal according to claim 7, wherein said controller is capable of controlling the operation of the light emitting elements to thereby illuminate all of said display.

9. A terminal according to claim 6, wherein said controller is capable of controlling the operation of the light emitting elements to thereby illuminate a region of said display upon which the at least one entry is presented.

10. A terminal according to claim 6 further comprising a housing capable of encapsulating at least a portion of the light emitting elements, wherein said controller is capable of controlling the operation of the light emitting elements to thereby illuminate at least a portion of said housing.

11. A method of identifying at least one entry from a listing produced by a terminal adapted to communicate via a communications system, wherein the terminal includes a plurality of light emitting elements having a plurality of different colors, said method comprising:
terminal
controlling the operation of the light emitting elements based upon a predefined color scheme associated with at least one predefined entry of a listing.

12. A method according to claim 11 further comprising presenting at least one entry from the listing upon a display of the terminal before controlling the operation of the light emitting elements, wherein controlling the operation comprises controlling the operation of the light emitting elements in response to the at least one entry presented upon the display based upon the predefined color scheme associated with at least one entry.

13. A method according to claim 12 further comprising associating the color scheme with at least one entry in the listing before presenting the at least one entry upon the display.

14. A method according to claim 13 further comprising organizing at least one entry in the listing such that at least one entry is associated with at least one caller group, wherein associating a color scheme comprises associating a color scheme with the at least one caller group, and wherein controlling the operation of the light emitting elements comprises controlling the operation of the light emitting elements based upon the color scheme associated with the caller group to which the at least one entry belongs.

15. A method according to claim 12, wherein the terminal further includes a keypad including a plurality of keys, said method further comprising associating at least one entry from the listing with at least one key, wherein controlling the operation of the light emitting elements comprises controlling the operation of the light emitting elements to also illuminate the at least one key associated with the at least one entry.

16. A method according to claim 12, wherein controlling the operation of the light emitting elements comprises controlling the operation of the light emitting elements to thereby illuminate at least a portion of the terminal.

17. A method according to claim 16, wherein controlling the operation of the light emitting elements comprises controlling the operation of the light emitting elements to thereby illuminate at least a portion of the display of the terminal.

18. A method according to claim 17, wherein controlling the operation of the light emitting elements comprises controlling the operation of the light emitting elements to thereby illuminate all of the display.

19. A method according to claim 16, wherein controlling the operation of the light emitting elements comprises controlling the operation of the light emitting elements to thereby illuminate a region of the display upon which the at least one entry is presented.

20. A method according to claim 16, wherein controlling the operation of the light emitting elements comprises controlling the operation of the light emitting elements to thereby illuminate at least a portion of a housing of the terminal.
